(19) United States
(12) Patent Application Publication
(10) Pub. No.: US 2010/0007044 A1
(43) Pub. Date: Jan. 14, 2010

(54) METHOD FOR PRODUCING A FIBRE COMPOSITE COMPONENT

(76) Inventors: Torben Jacob, Beckdorf (DE); Joachim Piepenbrock, Buxtehude (DE)

Correspondence Address: JENKINS, WILSON, TAYLOR & HUNT, P. A., Suite 1200 UNIVERSITY TOWER, 3100 TOWER BLVD.,, DURHAM, NC, 27707, US

(21) Appl. No.: 12/309,083

(22) PCT Filed: Jul. 4, 2007
(86) PCT No.: PCT/EP2007/056767

§ 371 Date: Jul. 6, 2009

Related U.S. Application Data
(60) Provisional application No. 60/818,777, filed on Jul. 6, 2006.

(30) Foreign Application Priority Data
Jul. 6, 2006 (DE) 10 2006 031 326.7

(51) Int. Cl. B29C 33/40; B28B 7/28

(52) U.S. Cl. 264/219; 249/175

(57) ABSTRACT

Disclosed is a moulding core for producing a fibre composite component, in particular a stringer on a base component in aerospace, of a spiral construction, wherein the moulding core is a hollow profile with an outer geometry adapted to the moulding core and with a slit provided in the wall of the hollow profile and extending spirally around its periphery; and wherein the slit hollow profile is provided with positional fixing, wherein the slit extending spirally around the periphery penetrates the wall of the hollow profile with the exception of at least three locations arranged such that they are distributed around the circumference of the wall of the hollow profile. A method for producing a fibre composite component, such as a fibre composite component for aerospace, is also disclosed.

### FIELD OF THE INVENTION

The present invention relates to a method for producing a fibre composite component, in particular for aerospace, to a moulding core for producing such a fibre composite component and to a fibre composite component with at least one stringer which is produced by means of such a moulding core and/or such a method.

Although it can be applied to any desired fibre composite components, the present invention and the problems on which it is based are explained in more detail below with reference to two-dimensional stringer-stiffened carbon fibre reinforced plastic (CRP) components, for example skin shells of an aircraft.

### BACKGROUND OF THE INVENTION

It is generally known to stiffen CRP skin shells with CRP stringers in order to withstand the high loads in the aircraft sector with the lowest possible additional weight. In this respect, a distinction is made essentially between two types of stringers: T and Ω stringers.

The cross section of T stringers is made up of a base and a stem. The base forms the connecting surface with respect to the skin shell. The use of skin shells stiffened with T stringers is widespread in aircraft construction.

Ω stringers have something like a hat profile, its ends being connected to the skin shell. Ω stringers may either be adhesively attached in the cured state to the likewise cured shell, or be cured wet-in-wet at the same time as the shell. The latter is desired, because it is more favourable from technical aspects of the process. However, supporting or moulding cores are necessary for the wet-in-wet production of skin shells stiffened with Ω stringers, in order to fix and support the dimensionally unstable semifinished fibre products in the desired Ω shape during the production process. Skin shells with Ω stringers have the advantage over T stringers that they allow better infiltration during an infusion process for introducing a matrix, for example an epoxy resin, into the semifinished fibre products. Infusion processes can be inexpensive in comparison with other known methods for producing fibre composite components, such as the prepreg process for example, because it allows the use of lower-cost semifinished fibre products.

However, there is the problem with the production of Ω stringers that the material used at present for the supporting or moulding core is cost-intensive and can only be removed with difficulty after the forming of the Ω stringers, with the result that the material remaining in the stringers contributes adversely to the overall weight of the aircraft.

### SUMMARY OF THE INVENTION

Against this background, it is one object of the present invention to provide a lower-cost and lighter fibre composite component, in particular for aerospace.

Accordingly, a method for producing a fibre composite component, in particular for aerospace, is provided, comprising the following method steps: forming a moulding core of a spiral construction to establish an outer geometry of the moulding core; at least partly laying at least one semifinished fibre product on the moulding core that is formed, for the shaping of at least one moulded portion of the fibre composite component to be produced; and exposure of the at least one moulded portion to heat and/or pressure to produce the fibre composite component.

Also provided is a moulding core for producing a fibre composite component, in particular a stringer on a base component in aerospace, of a spiral construction.

Also provided is a fibre composite component with at least one stringer in aerospace, which is produced by means of the moulding core according to the invention and/or the method according to the invention.

Consequently, the present invention has the advantage over the approaches mentioned at the beginning that the fibre composite component can be produced by means of a low-cost moulding core. Instead of cost-intensive conventional materials, a moulding core of a spiral construction, which can be removed from the mould in an advantageously easy way, is advantageously used, its easy removal providing weight advantages in comparision with conventional materials that remain in the component.

In one embodiment, it is provided that, when forming the moulding core, a hollow profile which has the outer geometry of the moulding core is provided with a slit extending spirally around its periphery, which slit is made in the wall of the hollow profile and penetrates the wall of the hollow profile completely or with the exception of at least three locations arranged such that they are distributed around the circumference of the wall of the hollow profile. The not completely penetrated locations serve as predetermined breaking points when the moulding core is removed from the mould and for stabilizing the hollow profile. If the hollow profile is completely slit, it is subsequently provided with positional fixing, for example by a lacquer coating, for example in an immersion bath. This may also be performed in the case of a non-slit hollow profile. Such a hollow profile can easily be produced from plastic in a moulding tool. An advantage of this is that the introduction of a peripheral slit allows the hollow profile to be easily removed from the mould by grasping it at one end and drawing it out from the moulded portion, no core component remaining in the moulded portion any longer. As it is drawn out, the hollow profile tears peripherally at the predetermined breaking points and peels off from the core sleeve as a result of the tensile force.

In an alternative embodiment, the moulding core is wound spirally from a wire, such as a steel wire, with the contour of the moulding core. To retain the shape and prevent it from springing back, the wire can be subjected to a heat treatment. This has the advantageous result that the wire of the moulding core is wound up when it is removed from the mould and can be reused or recycled.

In this case, the spiral moulding core may be provided with an outer coating, for example a brittle plastic mixed with fillers, a filled epoxy resin or a material similar to a lightweight knifing filler, for smoothing out ribbing of the metal wire, whereby smooth surfaces and good characteristics for removal from the mould are obtained. For this purpose, a core sleeve, for example a flexible tube, which completely surrounds the moulding core, may also be additionally used. This likewise produces characteristics for advantageously easy removal from the mould, without the moulded portion that is produced being damaged during removal.

According to a further exemplary embodiment of the invention, reinforcing means are arranged in the region of transitions, to be formed with sharp edges, of the outer geometry of the moulding core to be formed, inside the core sleeve. These reinforcing means, in particular corner profile parts, increase the edge strength, can simplify production and improve the quality of the component.

A release layer, which reduces adhesive attachment of the cured fibre composite component, may be applied to the core sleeve. This facilitates removal of the core sleeve after the moulding core has been drawn out.

Semifinished fibre products are to be understood as meaning woven or laid fabrics and fibre mats. These are impregnated with a matrix, for example an epoxy resin, and subsequently cured, for example with the aid of an autoclave.

According to a further embodiment of the invention, the moulding core is arranged on a base component comprising semifinished fibre composite products and/or is at least partially surrounded by semifinished fibre products to form at least one portion of the fibre composite component. Consequently, base parts, for example skin shells, pressure domes, etc. with Ω stringers can be advantageously formed. As an alternative or in addition, separate fibre composite components, which are defined entirely in their form by the moulding core, can also be produced.

The hollow profile may also be advantageously subjected to a relieving internal pressure, with the advantageous result that thin-walled hollow profiles can also be used. This internal pressure advantageously corresponds to the process pressure, that is to say atmospheric pressure when curing in an oven or autoclave pressure.

### BRIEF DESCRIPTION OF THE DRAWINGS

The present invention is explained in more detail below using exemplary embodiments and with reference to the attached figures of the drawings, in which:

FIG. 1 shows a schematic perspective view of a first exemplary embodiment of a fibre composite component during production as provided by a method according to the invention;

FIG. 2 shows a schematic, general sectional representation of a moulding core of the fibre composite component as shown in FIG. 1;

FIG. 3 shows a schematic perspective representation of a first exemplary embodiment of a moulding core according to the invention of the fibre composite component as shown in FIG. 1;

FIG. 4 shows a schematic perspective representation of a second exemplary embodiment of a moulding core according to the invention of the fibre composite component as shown in FIG. 1; and

FIG. 5 shows a schematic perspective view of the completed fibre composite component as shown in FIG. 1 after removal of the moulding cores.

In the figures, like reference numerals refer to identical or functionally identical components unless otherwise stated.

### DETAILED DESCRIPTION OF THE INVENTION

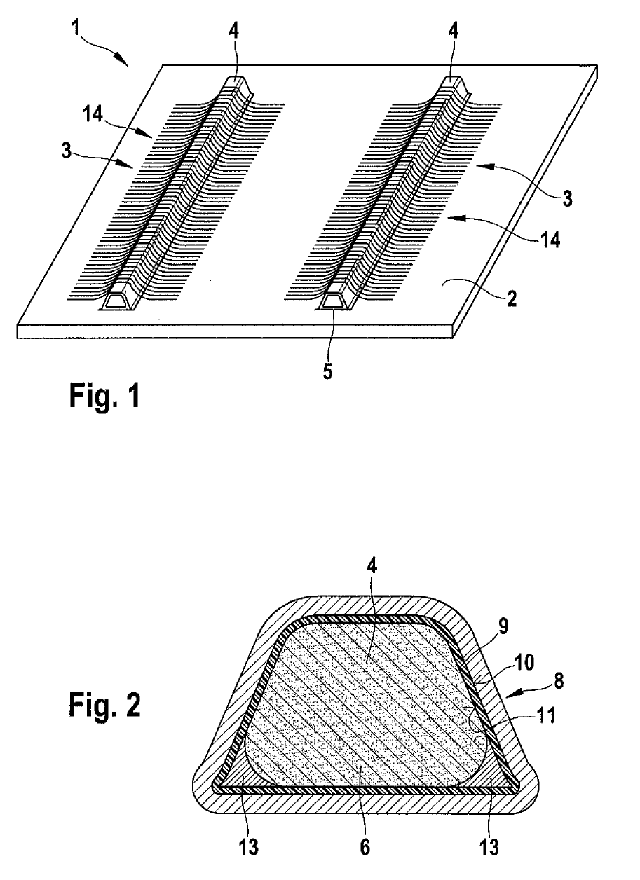

FIG. 1 shows a schematic perspective view of a first exemplary embodiment of a fibre composite component 1 during production as provided by a method according to the invention.

This example has two moulding cores 4, the number not being restricted to two. The two moulding cores 4, the production of which is explained further below, are provided with an approximately trapezoidal cross section with their base 5 resting on a base component 2.

The semifinished fibre products 3 are laid on the moulding cores 4. The semifinished fibre products 3 thereby lie with a middle portion on the outer surface of the moulding cores 4 and with their ends on the base component 2, for example on the skin of an aircraft. As a result, two moulded portions 14 of the fibre composite component 1 are formed.

Various production methods may be used for producing the fibre composite component. What is known as the infusion process may be chosen here in order to introduce a matrix, that is for example epoxy resin, into the semifinished fibre products 31, 33a, 33b. However, the prepreg process can similarly be used here.

In a further step, the base component 2 is cured with the moulding cores 4 and the semifinished fibre product 3 under the effect of heat and/or pressure in an oven or an autoclave, depending on the process used, whereby the complete fibre composite component 1 is produced. It is important here that the core materials reliably withstands the process temperature and the process pressure.

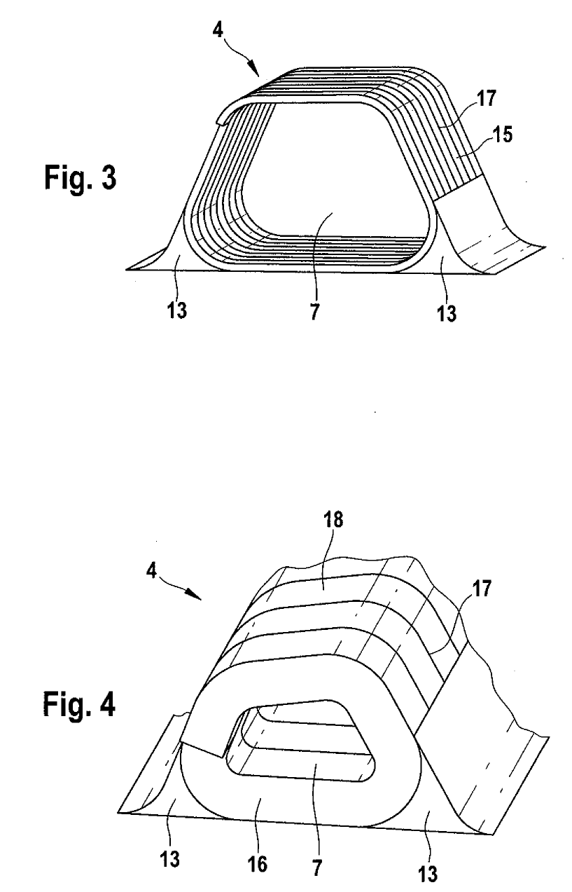

First, the production of the moulding cores 4 is described on the basis of FIGS. 2 and 4.

FIG. 2 shows a schematic, general sectional representation of a moulding core 4 according to the invention of the fibre composite component 1 as shown in FIG. 1 in a cross section.

The moulding core 4, the construction of which is discussed in detail further below, has a cross section 6 which is introduced into a moulding tool 8 and in this tool is brought into the desired shape, here an approximately trapezoidal form, for example under heat and pressure. In this example, the core material 7 is surrounded by a core sleeve 9, which completely encloses the moulding core 4 and is suitable for the method that is used for its production and its further working and processing, with regard to temperature and pressure. The core sleeve 9 is produced from a plastic, for example a polyamide and/or a PTFE plastic. It lies with its inner side 11 directly on the surfaces of the moulding core 4, in this example its outer side 10 being coated with a release layer (not shown), which may also comprise an additional sleeve. The release layer serves for the easy release of the moulding core 4 from the moulded portion 14 when it is removed from the mould.

To form sharp-edged corner regions, two reinforcing means 13 are provided in this example, which are produced separately and introduced into the moulding core 4. They may also be arranged outside the core sleeve 9.

The moulding core 4 comprises a first or second hollow profile 15, 16, which is provided with a slit 17 extending spirally around its periphery, as represented in FIGS. 3 and 4. In order to obtain adequate stability of the slit hollow profile 15, 16, at least three locations that are not penetrated are provided on the circumference and tear as predetermined breaking points when the hollow profile 15, 16 is drawn out during removal. These predetermined breaking points may be created for example in such a manner that at least 3 thickened portions of the wall that are distributed over the circumference are provided towards the inside. With a constant slit depth, which corresponds to the rest of the wall, fixing connections then remain over the thickened portions.

Alternatively, the hollow profile 15, 16 may be cut into completely, in which case however positional fixing is necessary, for example by a suitable lacquer coating, which is performed for example in an immersion bath. In both cases, the hollow profile 15, 16 comprises an adequately tough and tear-resistant plastic. This produces the advantage that complete removal is made possible when it is removed from the mould.

In a first embodiment, the hollow profile 15 represented in FIG. 3 comprises a thin-walled plastic profile. In the production of the moulded portion 14, it is possible for the purposes of stabilization for the interior space of the hollow profile 15 to be subjected to an internal pressure (ambient pressure; autoclave or atmospheric pressure, depending on the curing process) through a core opening 7 by means of a suitable connection device (not shown). As a result, the pressure difference between the interior space and the exterior vacuum that is built up is equal to zero and therefore can no longer deform the hollow profile. It accordingly then only assumes a shaping function. Consequently, the thin-walled nature of the hollow profile 15 can achieve the advantage of saving material. To subject it to an internal pressure, the moulding core 4 is arranged in the moulded portion 14 (FIG. 1) in such a way that its ends protrude from the moulded portion 14.

In an alternative embodiment, the hollow profile 15 comprises a wound wire, such as a steel wire. In order to prevent this material from springing back, during and/or after production the wire spiral is subjected to a suitable heat treatment, for example soft annealing or processing in the temperature range of hot forming and subsequent hardening. At the same time, sharp inner radii can be achieved in this way. If a wire with a thickness of, for example, 1.5 mm is used, this inevitably produces outer radii of at least 0.8 mm, which can be made correspondingly sharp by contour smoothing and/or a corner profile.

In FIG. 3, reinforcing means 13 in the form of such corner profiles, for example strips of metal or plastic, are used at the lower corners. In this way, the moulding core 4 can be provided with particularly well-formed corner regions, by the reinforcing means 13 being produced in a separate tool. The cross section of the corner profiles in FIG. 3 is shown greatly enlarged. They may be arranged outside the core sleeve 9 (not shown in FIG. 3) or else inside it (if, unlike the representation in FIG. 3, the overall cross section does not have any concave regions that would otherwise be spanned by the sleeve).

The slit 17 or intermediate spaces between the windings or the ribbing of the wound wire are smoothed by a coating. This coating prevents the surface waviness of a wire winding from striking through onto the moulded portion 14. At the same time, this coating brings about fixing of the hollow profile or the wire spiral against twisting and uncoiling. The coating is a brittle material, which flakes off and crumbles away during removal from the mould, so that the operation is not hindered. This material is, for example, a brittle plastic mixed with fillers, a filled epoxy resin or a material similar to a light-weight knifing filler.

FIG. 4 shows an alternative, in which the hollow profile 16 is produced from a thick-walled plastic or a rectangular wire. In this case, there is no need for contour smoothing. The winding is in this case produced without any twist, producing a closed outer side 18 without steps or gaps.

The moulding core 4 created in this way is applied to the base component 2 as described above. This state is shown in FIG. 1. The moulding core 4 is then covered over with the semifinished fibre product 3 to form the moulded portion 14, as explained above.

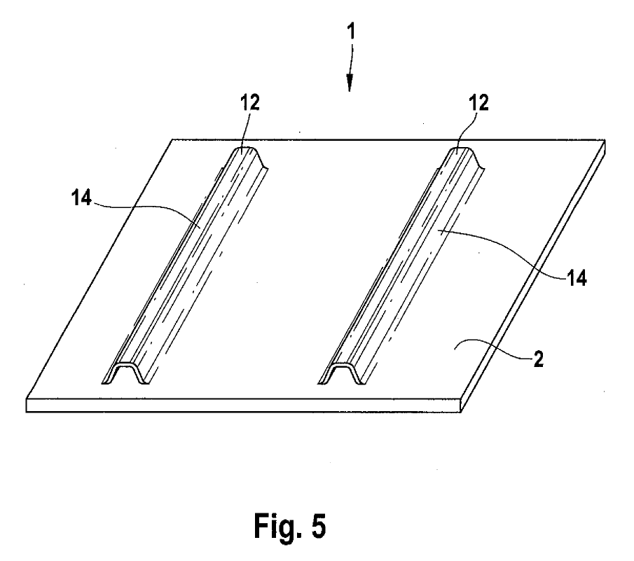

The fibre composite component 1 produced by a curing cycle (not explained in any more detail) is represented in FIG. 5 in a perspective view, with moulded portions 14 formed as stringers 20, after removal of the moulding cores 4.

During removal from the mould, the outer end of the cut-into hollow profile 15, 16 or of the wound wire is grasped in an advantageously easy way and drawn out from the moulded portion 14. The removed material can be wound up and reused/recycled. The core sleeve 9 is subsequently likewise drawn out, which can be performed particularly advantageously easily if a release layer is present. The fibre composite component 1 can then be further processed or used directly. In the case of reinforcing means 13, they are likewise drawn out at the same time.

Remains of a fixing material and/or of contour smoothing are removed by the drawing out of the core sleeve 9.

Consequently, a method for producing a fibre composite component, a corresponding moulding core and a corresponding fibre composite component that can achieve a significant reduction in material costs in comparison with the prior art with conventional core materials that remain in it are provided. The moulding core is completely removed, whereby the weight of the fibre composite component can be reduced in comparison with the prior art.

The invention is not restricted to the specific method represented in the figures for producing a fibre composite component 1 for aerospace.

For example, the idea of the present invention can also be applied to fibre composite components in the sports equipment or motor sports sector.

Furthermore, the geometry of the moulding core can be modified in various ways.

Furthermore, it is also possible for a number of moulding cores to be used to form one moulding core, around which semifinished fibre products are placed. The aim of this is to create a more complex geometry by means of the multiplicity of moulding cores. Consequently, more complex fibre composite components can be produced.

The application of the coating for contour smoothing can be performed in an automated manner, as an application close to the final contour, in an installation similar to what is known as a pultrusion press, through which the hollow profile or the winding is drawn. A bending radius of the wire winding can in this way be filled.

A thick-walled spiral profile, for example of an elastomeric plastic, may also be used as the hollow profile.

In one embodiment of the method for producing a fibre composite component 1, when winding the moulding core 4, a heat treatment of the wire is performed to avoid springing back.

In another embodiment of the method for producing a fibre composite component 1, the method is a hand lay-up, prepreg, transfer moulding and/or vacuum infusion process.

In one embodiment of the moulding core 4 for producing a fibre composite component 1, the reinforcing means 13 are formed as corner profile parts of metal and/or plastic.

In another embodiment of the moulding core 4 for producing a fibre composite component 1, the moulding core 4 is formed such that it is □-shaped, trapezoidal, triangular, annular and/or wavy.

The following is an overview of the embodiments disclosed in this specification:

### Embodiment 1

A method for producing a fibre composite component, in particular for aerospace, comprising the following method steps:
forming a moulding core having a spiral configuration for establishing an outer geometry of the moulding core, wherein, when forming the moulding core, a hollow profile with an outer geometry adapted to the moulding core and with a slit provided in the wall of the hollow profile and extending spirally around its periphery is formed and the slit hollow profile is provided with positional fixing, wherein the slit extending spirally around the periphery penetrates the wall of the hollow profile with the exception of at least three locations arranged such that they are distributed around the circumference of the wall of the hollow profile;
at least partly laying at least one semifinished fibre product on the moulding core that is formed, in order to shape at least one moulded portion of the fibre composite component to be produced; and
exposing the at least one moulded portion to heat and/or pressure to produce the fibre composite component.

### Embodiment 2

The method according to Embodiment 1, wherein the slit hollow profile is provided with positional fixing, for example with a lacquer coating, for example in an immersion bath.

### Embodiment 3

A method for producing a fibre composite component, in particular for aerospace, comprising the following method steps:
forming a moulding core having a spiral configuration for establishing an outer geometry of the moulding core, wherein, when forming the moulding core, a hollow profile with an outer geometry adapted to the moulding core and with a slit provided in the wall of the hollow profile and extending spirally around its periphery is formed and the slit hollow profile is provided with positional fixing, wherein the slit extending spirally around the periphery penetrates the wall of the hollow profile completely and, for positional fixing, the slit hollow profile is provided with a coating, for example a lacquer coating, for example in an immersion bath;
at least partly laying at least one semifinished fibre product on the moulding core that is formed, in order to shape at least one moulded portion of the fibre composite component to be produced; and
exposing the at least one moulded portion to heat and/or pressure to produce the fibre composite component.

### Embodiment 4

A method for producing a fibre composite component, in particular for aerospace, comprising the following method steps:
forming a moulding core having a spiral configuration for establishing an outer geometry of the moulding core, wherein, when forming the moulding core, a hollow profile with an outer geometry adapted to the moulding core is formed from a spirally wound wire, and the moulding core is provided with an outer coating for the smoothing out of ribbing and positional fixing of the wire;
at least partly laying at least one semifinished fibre product on the moulding core that is formed, in order to shape at least one moulded portion of the fibre composite component to be produced; and
exposing the at least one moulded portion to heat and/or pressure to produce the fibre composite component.

### Embodiment 5

The method according to Embodiment 4, wherein the wire is a steel wire.

### Embodiment 6

Method according to either of Embodiments 4 and 5, wherein the outer coating of the moulding core is brittle plastic mixed with fillers, filled epoxy resin or a material similar to a lightweight knifing filler.

### Embodiment 7

The method according to any of Embodiments 4 to 6, wherein, when winding the moulding core, a heat treatment of the wire is performed to avoid springing back.

### Embodiment 8

The method according to any of the preceding Embodiments, wherein, when forming the moulding core, reinforcing means are arranged in the region of transitions, to be formed with a sharp edge, of the outer geometry of the moulding core to be formed.

### Embodiment 9

A method for producing a fibre composite component, in particular for aerospace, comprising the following method steps:
forming a moulding core having a spiral configuration for establishing an outer geometry of the moulding core, wherein, when forming the moulding core, a hollow profile with an outer geometry adapted to the moulding core and with a slit provided in the wall of the hollow profile and extending spirally around its periphery is formed and the slit hollow profile is provided with positional fixing;
at least partly laying at least one semifinished fibre product on the moulding core that is formed, in order to shape at least one moulded portion of the fibre composite component to be produced; and
exposing the at least one moulded portion to heat and/or pressure to produce the fibre composite component,

wherein when forming the moulding core, reinforcing means are arranged in the region of transitions, to be formed with a sharp edge, of the outer geometry of the moulding core to be formed.

### Embodiment 10

The method according to Embodiment 9, wherein the positional fixing is formed by the slit that is provided in the wall of the hollow profile and extends spirally around its periphery penetrating through the wall of the hollow profile with the exception of at least three locations arranged such that they are distributed around the circumference of the wall of the hollow profile.

### Embodiment 11

The method according to Embodiment 9, wherein the slit that is provided in the wall of the hollow profile and extends spirally around its periphery penetrates through the wall of the hollow profile completely and, for positional fixing, the slit hollow profile is provided with a coating, for example a lacquer coating, for example in an immersion bath.

### Embodiment 12

The method according to any of the Embodiments 9 to 11, wherein the slit hollow profile is provided with positional fixing, for example with a lacquer coating, for example in an immersion bath.

### Embodiment 13

The method according to any of the preceding Embodiments, wherein the moulding core is formed with a core sleeve, in particular a flexible tube, which completely surrounds the moulding core.

### Embodiment 14

The method according to Embodiment 13, wherein a release layer, which reduces adhesive attachment of the semifinished fibre product and/or a matrix to the core sleeve, is applied to the core sleeve of the moulding core.

### Embodiment 15

The method according to any of the preceding Embodiments, wherein, during the at least partial laying of at least one semifinished fibre product, the moulding core is arranged on a base component comprising semifinished fibre composite products and/or is at least partially surrounded by semifinished fibre products to form the at least one moulded portion of the fibre composite component, the interior of the moulding core being subjected to an internal pressure that can be fixed, and the ends of the core sleeve of the moulding core being arranged outside the moulded portion.

### Embodiment 16

The method according to any of the preceding Embodiments, wherein a matrix is introduced into the at least one semifinished fibre product with the moulding core and is subsequently at least partially cured under pressure and/or heat.

### Embodiment 17

The method according to any of the preceding Embodiments, wherein the method for producing the fibre composite component is a hand lay-up, prepreg, transfer moulding and/or vacuum infusion process.

### Embodiment 18

The method according to any of the preceding Embodiments, wherein, after exposing the fibre composite component to be produced to heat and/or pressure, removal of the moulding core is performed by drawing out one or both ends of the spiral construction and optionally winding it up.

### Embodiment 19

A moulding core for producing a fibre composite component, in particular a stringer on a base component in aerospace, of a spiral construction, wherein the moulding core is a hollow profile with an outer geometry adapted to the moulding core and with a slit provided in the wall of the hollow profile and extending spirally around its periphery; and
in that the slit hollow profile is provided with positional fixing, wherein the slit extending spirally around the periphery penetrates the wall of the hollow profile with the exception of at least three locations arranged such that they are distributed around the circumference of the wall of the hollow profile.

### Embodiment 20

The moulding core according to Embodiment 19, wherein, to form the positional fixing, the slit hollow profile is provided with a coating, for example a lacquer coating.

### Embodiment 21

A moulding core for producing a fibre composite component, in particular a stringer on a base component in aerospace, of a spiral construction, wherein the moulding core is a hollow profile with an outer geometry adapted to the moulding core and with a slit provided in the wall of the hollow profile and extending spirally around its periphery, wherein the slit penetrates the wall of the hollow profile completely and, to form the positional fixing, the slit hollow profile is provided with a coating, for example with a lacquer coating, for example in an immersion bath.

### Embodiment 22

A moulding core for producing a fibre composite component, in particular a stringer on a base component in aerospace, of a spiral construction, wherein the moulding core is a hollow profile with an outer geometry adapted to the moulding core and with a slit provided in the wall of the hollow profile and extending spirally around its periphery; and
in that the slit hollow profile is provided with positional fixing, wherein reinforcing means are arranged in the moulding core in the region of transitions, to be formed with sharp edges, of its outer geometry.

### Embodiment 23

The moulding core according to Embodiment 24, wherein the reinforcing means are formed as corner profile parts of metal and/or plastic.

### Embodiment 24

The moulding core according to any of Embodiments 19 to 23, wherein the hollow profile has a thin plastic wall.

### Embodiment 25

The moulding core according to any of Embodiments 19 to 24, wherein the moulding core is a hollow profile, for example a thick-walled spiral profile, of an elastomer.

### Embodiment 26

A moulding core for producing a fibre composite component, in particular a stringer on a base component in aerospace, of a spiral construction, wherein the moulding core is a spirally wound wire in the form of a hollow profile with an outer geometry adapted to the moulding core, the moulding core being provided with an outer coating, wherein the outer coating of the moulding core is a brittle plastic mixed with fillers, a filled epoxy resin or a material similar to a lightweight knifing filler for the smoothing out of ribbing and positional fixing of the wire.

### Embodiment 27

The moulding core according to Embodiment 26, wherein the wire has a rectangular cross section.

### Embodiment 28

The moulding core according to either of Embodiments 26 and 27, wherein reinforcing means are arranged in the moulding core in the region of transitions, to be formed with sharp edges, of its outer geometry.

### Embodiment 29

The moulding core according to Embodiment 28, wherein the reinforcing means are formed as corner profile parts of metal and/or plastic.

### Embodiment 30

The moulding core according to any of Embodiments 19 to 29, wherein the moulding core is provided with a core sleeve, for example a flexible tube, enclosing it.

### Embodiment 31

The moulding core according to Embodiment 30, wherein the core sleeve has a release layer, for example in the form of a further sleeve, which forms an outer surface of the moulding core.

### Embodiment 32

The moulding core according to either of Embodiments 30 and 31, wherein the core sleeve is produced from a plastic, in particular a polyamide and/or a PTFE plastic.

### Embodiment 33

The moulding core according to any of Embodiments 19 to 32, wherein the moulding core is formed such that it is i-shaped, trapezoidal, triangular, annular and/or wavy.

What is claimed is:

1. A method for producing a fibre composite component, such as a fibre composite component for aerospace, comprising the following method steps:
forming a moulding core having a spiral configuration for establishing an outer geometry of the moulding core, wherein, when forming the moulding core, a hollow profile with an outer geometry adapted to the moulding core and with a slit provided in the wall of the hollow profile and extending spirally around its periphery is formed and the slit hollow profile is provided with positional fixing, wherein the slit extending spirally around the periphery penetrates the wall of the hollow profile with the exception of at least three locations arranged such that they are distributed around the circumference of the wall of the hollow profile;
at least partly laying at least one semifinished fibre product on the moulding core that is formed, in order to shape at least one moulded portion of the fibre composite component to be produced; and
exposing the at least one moulded portion to heat and/or pressure to produce the fibre composite component.

2. The method according to claim 1, wherein the slit hollow profile is provided with positional fixing, for example with a lacquer coating, for example in an immersion bath.

3. The method according to claim 1 wherein, when forming the moulding core, reinforcing means are arranged in the region of transitions, to be formed with a sharp edge, of the outer geometry of the moulding core to be formed.

4. The method according to claim 1, wherein the moulding core is formed with a core sleeve, such as a flexible tube, which completely surrounds the moulding core.

5. The method according to claim 1, wherein a release layer, which reduces adhesive attachment of the semifinished fibre product and/or a matrix to the core sleeve, is applied to the core sleeve of the moulding core.

6. The method according to claim 1, wherein, during the at least partial laying of at least one semifinished fibre product, the moulding core is arranged on a base component comprising semifinished fibre composite products and/or is at least partially surrounded by semifinished fibre products to form the at least one moulded portion of the fibre composite component, the interior of the moulding core being subjected to an internal pressure that can be fixed, and the ends of the core sleeve of the moulding core being arranged outside the moulded portion.

7. The method according to claim 1, wherein a matrix is introduced into the at least one semifinished fibre product with the moulding core and is subsequently at least partially cured under pressure and/or heat.

8. The method according to claim 1, wherein the method for producing the fibre composite component is a hand lay-up, prepreg, transfer moulding and/or vacuum infusion process.

9. The method according to claim 1, wherein, after exposing the fibre composite component to be produced to heat and/or pressure, removal of the moulding core is performed by drawing out one or both ends of the spiral construction and optionally winding it up.

10. A moulding core for producing a fibre composite component, such as a stringer on a base component in aerospace, of a spiral construction, wherein the moulding core is a hollow profile with an outer geometry adapted to the moulding core and with a slit provided in the wall of the hollow profile and extending spirally around its periphery; and
wherein the slit hollow profile is provided with positional fixing, wherein the slit extending spirally around the periphery penetrates the wall of the hollow profile with the exception of at least three locations arranged such that they are distributed around the circumference of the wall of the hollow profile.

11. The moulding core according to claim 10, wherein, to form the positional fixing, the slit hollow profile is provided with a coating, for example a lacquer coating.

12. The moulding core according to claim 10, wherein the hollow profile has a thin plastic wall.

13. The moulding core according to claim 10, wherein the moulding core is a hollow profile, for example a thick-walled spiral profile, of an elastomer.

14. The moulding core according to claim 10, wherein the moulding core is provided with a core sleeve, for example a flexible tube, enclosing it.

15. The moulding core according to claim 14, wherein the core sleeve comprises a release layer, for example in the form of a further sleeve, which forms an outer surface of the moulding core.

16. The moulding core according to claim 14, wherein the core sleeve is produced from a plastic, such as a polyamide and/or a PTFE plastic.

17. The moulding core according to claim 10, wherein the moulding core is formed such that it is Ω-shaped, trapezoidal, triangular, annular and/or wavy.

18.-33. (canceled)
